(19) United States
(12) Patent Application Publication
(10) Pub. No.: US 2011/0186200 A1
(43) Pub. Date: Aug. 4, 2011

(54) TUBLESS TIRE

(75) Inventors: Ying-Ming Yang, Yuanlin Chang Hwa Hsien (TW); Tsung-Yueh Lai, Yuanlin Chang Hwa Hsien (TW); Chin-Hsin Lai, Yuanlin Chang Hwa Hsien (TW)

(73) Assignee: KENDA RUBBER IND. CO., LTD., Yuanlin Chang Hwa Hsien (TW)

(21) Appl. No.: 12/761,079

(22) Filed: Apr. 15, 2010

(30) Foreign Application Priority Data
Jan. 29, 2010 (TW) 99102739

(51) Int. Cl. B60C 9/12; B60C 5/14

(52) U.S. Cl. 152/458; 152/510

(57) ABSTRACT

A tubeless tire includes a carcass covered with a first impermeable layer and a second impermeable layer. The first and second impermeable layers have portions overlapped to obtain a good airtight property. The first impermeable layer includes a composite compound with strength reinforced powder, an intersection carrier and rubber that the tire is strengthened and light in weight. The tubeless tire of the present invention further has a thread on the first impermeable layer to contact ground.

### BACKGROUND OF THE INVENTION

1. Field of the Invention

The present invention relates generally to a tire, and more particularly to a tubeless tire, which has a lighter weight, good protection from being pierced through, and good airtight condition.

2. Description of the Related Art

FIG. 1 shows a conventional tubeless tire 1, which includes a cord layer 2, a reinforced layer 3, a thread 4, and an impermeable layer 5.

The cord layer has two beaded edges 2a at opposite sides, in which a steel wire 6 is embedded. The steel wire 6 can keep the shape of the tire 1 and press the beaded edges 2a on a bead seat 7a of a wheel rim 7 tightly for airtight. For reinforcement of the strength of the tire 1 to prevent it from being pierced through and cut, the reinforced layer 3 is provided on an outer side 2b of the cord layer 2. The thread 4, which is on an outer side of the reinforced layer 3, is a surface of the tire 1. For safety, the thread 4 is made of a rubber with low structure density to provide good traction. The thread 4 may be made of another rubber also or treated by a specific process at a middle portion thereof for high speed racing. The impermeable layer 5 is to keep an airtight condition of the tire 1 that the location thereof is behind the cord layer 2. Some conventional tires are simply coated with sealant on an inner side of the cord layer 2 for the impermeable layer 5, and some provides a rubber with high structure density to be the impermeable layer 5.

However, the conventional impermeable layer 5 cannot prevent the air leakage, and the reasons are listed below:

1. The sealant impermeable layer is affected by temperature. The rubber impermeable layer is heavy that the tire cannot reduce the weight.

2. The sealant impermeable layer will be stretched to break down the airtight condition when the tire 1 is inflated, and so will the rubber impermeable layer. A conventional way of fixing this problem is to increase the thickness of the impermeable layer. However, it will increase the weight of tire 1.

3. Both of the sealant impermeable layer and the rubber impermeable layer are provided at inner side of the cord layer 2 that the cord layer 2 will be damaged and exploded before the impermeable layer when the tire 1 is pierced or cut. Furthermore, it may cause stones or other unexpected stuff stuck on the tire 1 to affect the tire's capacity.

### SUMMARY OF THE INVENTION

The primary objective of the present invention is to provide a tubeless tire, which has a lighter weight, good protection from being pierced through, and good airtight condition.

According to the objective of the present invention, a tubeless tire includes a carcass, a first impermeable layer, a second impermeable layer, and a thread. The carcass has a crown, two sidewalls connected to opposite sides of the crown, and two beads at distal ends of the crown. The first impermeable layer includes a composite compound with strength reinforced powder, an intersection carrier and rubber. The first impermeable layer is attached on outer surfaces of the crown and the sidewalls. The second impermeable layer is attached on outer surfaces of the beads. The first and second impermeable layers have portions overlapped. The thread is attached on the impermeable layer.

The intersection carrier of the first impermeable layer is an intersected bulletproof fiber web with an intersection density between 30 fibers×30 fibers per square inch and 120 fibers×120 fibers per square inch, and an intersection density of the second impermeable layer is between 20 fibers×20 fibers per square inch and 80 fibers×80 fibers per square inch to provide a reduced weight and a good resistance to piercing and cutting.

### BRIEF DESCRIPTION OF THE DRAWINGS

FIG. 1 is a sectional view of the conventional tubeless tire;

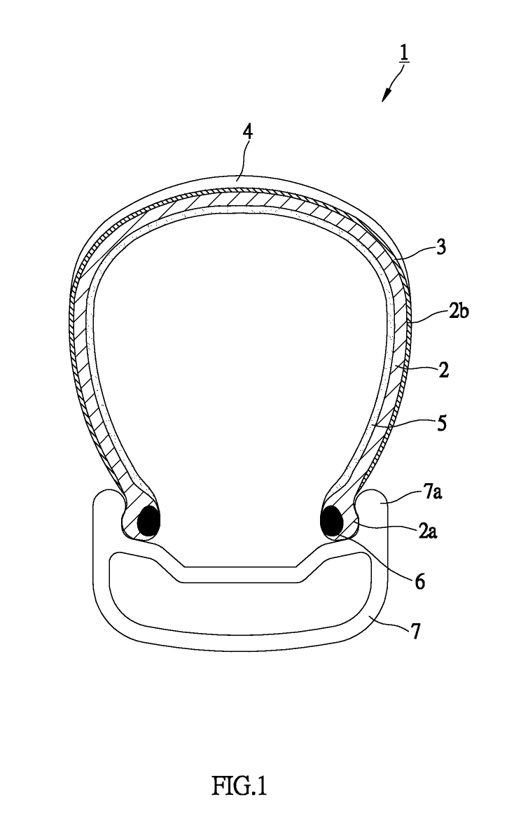

FIG. 2 is a sectional view of a first preferred embodiment of the present invention; and

FIG. 3 is a sectional view of a second preferred embodiment of the present invention.

### DETAILED DESCRIPTION OF THE INVENTION

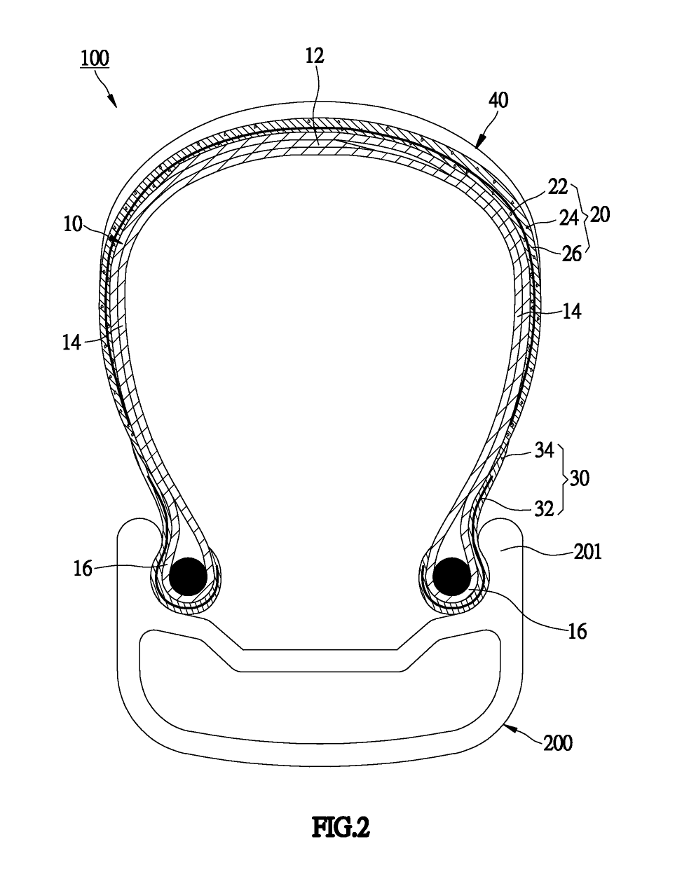

As shown in FIG. 2, a tubeless tire 100 of the first preferred embodiment of the present invention includes a carcass 10, a first impermeable layer 20, a second layer 30, and a thread 40.

The carcass 10 is made by a rubber with Kevlar fibers, whose intersection density thereof is in a range between 60 fibers and 300 fibers per square inch. In the present embodiment, the Kevlar fibers are intersected in 110 fibers×110 fibers. The carcass 10 is the same as one in the conventional tires, so we do not describe the detail here. The carcass 10 of the present invention includes a crown 12, two sidewalls 14 connected to opposite sides of the crown 12, and two beads 16 at distal ends of the sidewalls 14.

The first impermeable layer 20 is made of a composite compound with an intersection carrier 22, strength reinforced powder 24, and rubber 26 on surfaces of crown 12 and the sidewalls 14. In the present invention, the intersection carrier 22 is made of bulletproof fibers with an intersection density between 30 fibers×30 fibers and 120 fibers×120 fibers, and the intersection carrier 22 is inextensible. In the present invention, the intersection carrier 22 is 66 fibers×55 fibers. The intersection carrier 22 may be made of aromatic polyamide fibers (so called Kevlar fibers) or ultra high molecular weight polyethylene (so called Dyneema fibers). In the present invention, the intersection carrier 22 is made of Kevlar fibers. In practice, the intersection carrier 22 may be made of any suitable material, such as nylon or other fibers.

The strength reinforced powder 24 of the first impermeable layer 20 may be bulletproof ceramics powder, hollow glass pellets, glass fiber powder, Kevlar fiber powder or metallic powder. In the present invention, the strength reinforced powder 24 is bulletproof ceramics powder.

The second impermeable layer 30 is made of a composite compound with an intersection carrier 32 and rubber 34 on surfaces of bead portions 16 of the carcass 10 and has a portion overlapped with the first impermeable layer 20. The second impermeable layer 30 is tightly in contact with a bead seat 201 of a wheel rim 200. The intersection carrier 32 and the rubber 34 of the second impermeable layer 30 may be the same as material of the intersection carrier 22 and rubber 26 of the first impermeable layer 20. The difference is that the intersection carrier 32 of the second impermeable layer 30 has an intersection density between 20 fibers×20 fibers and 80 fibers×80 fibers which is lower than that of the first impermeable layer 20. In the present invention, the intersection density of the second impermeable layer 30 is 40 fibers×40 fibers.

The thread 40, which is the portion of the tire contacting ground, is made of rubber and is on the first impermeable layer 20.

Above are the elements and structure of the present invention, and the functions and advantages of the present invention are:

1. The first and second impermeable layers 20 and 30, which serve the function of anti-leakage, are on the outer side of the carcass 10, which is the main structure of the tire 100, and the first impermeable layer 20 has strength reinforced powder 24 that the tire 100 of the present invention has superior resistance to piercing, cutting, and wearing when the tire 100 is exerted by sharp substances or bumpy ground. The present invention also has a greater wear resistance property that may increase the durability. Besides, the carcass 10 is behind the first and second impermeable layers 20 and 30 that the carcass 10 will not be stuck with unexpected substances.

2. The first impermeable layer 20 includes the high intersection density and light composite compound of bulletproof fiber and rubber to increase the airtight property and reduce the weight.

3. The second impermeable layer 30 is overlapped with the first impermeable layer 20 to increase the airtight property. The second impermeable layer 30 includes the intersection carrier 32 to increase wear resistance property thereof while in contact with the bead seat 201 of the wheel rim 200.

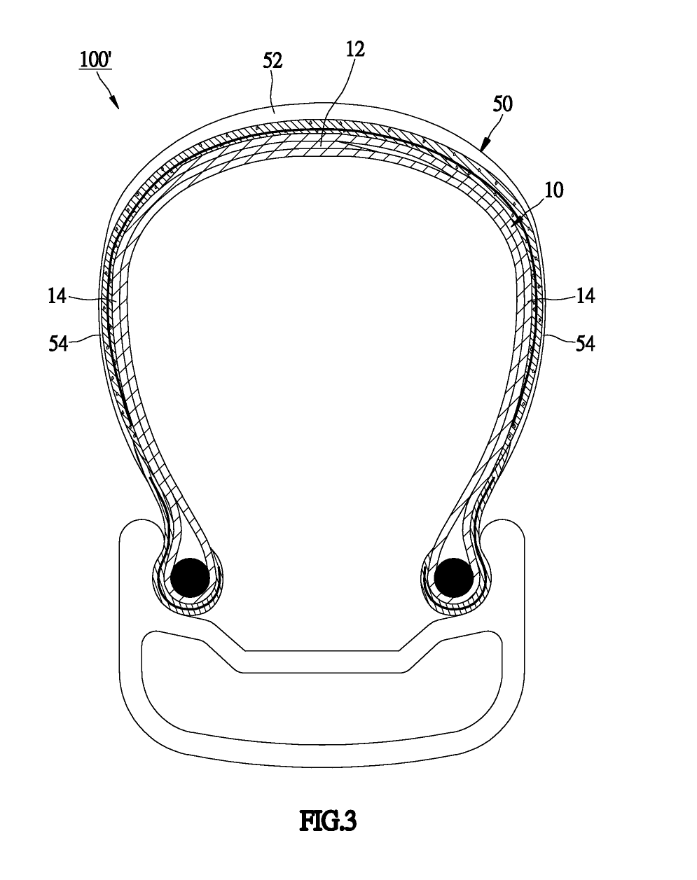

4. FIG. 3 shows a tire 100′ of the second preferred embodiment of the present invention, which is similar to the tire 100 of the first preferred embodiment, except that a thread 50 of the tire 100′ includes a crown thread 52 and two sidewall portions 54 at opposite sides of the crown thread 52. The crown thread 52 is on the crown 12 of the carcass 10 to contact ground, and the sidewall portions 54 are on the sidewalls 14 of the carcass 10 to strengthen sides of the tire 100′.

The description above is a few preferred embodiments of the present invention and the equivalence of the present invention is still in the scope of claim construction of the present invention.

What is claimed is:

1. A tubeless tire, comprising:
a carcass including a crown, two sidewalls connected to opposite sides of the crown, and two beads at distal ends of the crown; and
a first impermeable layer, which includes a composite compound with strength reinforced powder, an intersection carrier and rubber, attached on outer surfaces of the crown and the sidewalls;
a second impermeable layer, which includes a composite compound with an intersection carrier and rubber, attached on outer surfaces of the beads, and having a portion overlapped with the first impermeable layer; and
a thread attached on the impermeable layer.

2. The tubeless tire as defined in claim 1, wherein the intersection carriers of the first impermeable layer and the second impermeable layer are inextensible.

3. The tubeless tire as defined in claim 1, wherein the intersection carrier of the first impermeable layer is made of intersected fibers with an intersection density between 30 fibers×30 fibers per square inch and 120 fibers×120 fibers per square inch.

4. The tubeless tire as defined in claim 3, wherein the fibers of the first impermeable layer are bulletproof fibers.

5. The tubeless tire as defined in claim 4, wherein the bulletproof fiber is selected from the group consisting of aromatic polyamide fiber and ultra high molecular weight polyethylene fiber.

6. The tubeless tire as defined in claim 3, wherein the fibers of the first impermeable layer are nylon fibers.

7. The tubeless tire as defined in claim 1, wherein the strength reinforced powder of the first impermeable layer is made of a material selected from the group consisting of bulletproof ceramics powder, hollow glass pellets, glass fiber powder, Kevlar fiber powder and metallic powder.

8. The tubeless tire as defined in claim 1, wherein the thread includes a crown thread and two sidewall portions at opposite sides of the crown thread, and the crown thread is on the crown of the carcass and the sidewall portions are on the sidewalls of the carcass.
